(19) United States
(12) Patent Application Publication
(10) Pub. No.: US 2010/0035357 A1
(43) Pub. Date: Feb. 11, 2010

(54) Apparatus For Optically Reading Test Kits And Identification Data Associated Therewith

(76) Inventors: Ziv Geva, Rehovot (IL); Ofer Leizerovich, Nes-Ziona (IL)

Correspondence Address: The Law Office of Michael E. Kondoudis, 888 16th Street, N.W., Suite 800, Washington, DC, 20006, US

(21) Appl. No.: 12/185,901

(22) Filed: Aug. 5, 2008

(51) Int. Cl. G01N 21/00

(52) U.S. Cl. 436/164; 422/82.05

(57) ABSTRACT

A method and an apparatus for optically reading test kits having an identification data zone associated with the test kit and test zone arranged to receive a test substance. The apparatus comprises an optical sensing module, an image-processing module coupled to the optical sensing module, a control module coupled to the optical sensing module and to the image-processing module. The optical sensing module is arranged to sense both the test zone and the identification data zone and deliver the sensed data to the image processing module responsive to the control module. Further, the image-processing unit is arranged to perform image processing on the sensed data from the test zone and from the identification data zone and further determine the test substance according to the sensed data from the test zone in view of the sensed data from the identification data zone responsive to the control unit.

### TECHNICAL FIELD

The present invention relates to portable readers for the examination of biological and chemical specimens on test kits, and in particular to such devices that enable the optical reading of data pertaining to the specimens as well as data pertaining to the test kit, the patient, donor or person in charge to conduct the test.

### BACKGROUND OF THE INVENTION

Rapid test kits directed at examining chemical and biological substances for analysis and diagnostic purposes are widely used and are constantly replacing some of the traditional laboratory tests. Theses test kits cover various types of tests and are used for example, in human diagnostics, veterinary uses, food and environmental tests.

Many of these test kits utilize a chemically responsive substance contained in a predefined zone on the test kit. The chemically responsive substance is selected such that it interacts with the test specimen and present optical formation representing the detected substance in the specimen in accordance with predefined parameters. The optical representation may be either qualitative (e.g., binary or discrete value) or quantitative (e.g., specified by the intensity, shape or color of the reaction, or by a combination. A test kit might contain a control zone to verify that the test is valid, and also might contain several tests zone, either for the same test or for multiple tests on the same test kit).

Digital readers for the examination of test kits focusing on optical image processing are becoming available, and are designed such that they imitate the diagnostic method performed manually, either with bare eyes or by using a microscope or magnifying glasses. These readers further employ image-processing techniques in order to improve the human acts of examination and diagnosis. The improvements are achieved by applying additional sensitivity and abilities such as providing numeric results supporting wavelength beyond the eye, adding storage and connectivity, etc. The rapid test kits are provided with designated area on which the specimen is held and where the chemically responsive substance is embedded thereon.

Some rapid test kits are operating when associated with a reader to which the test kit is connected or coupled. The reader is arranged to communicate with an examination device and to receive additional data relating to the specimen such as test identification, patient information and specific batch information. The data is then further processed for diagnostic purposes.

Several attempts are known in the art to design portable devices for the examination of bodily substances and other chemical specimens.

In many cases data that is unique to a specific examination device is of high importance for obtaining an optimal and precise diagnostic process. This data usually pertains to technical details relating to the production process of the specific examination device such as batch number, date of production, model and type of device and the like. This device related data is pertinent to calibration process of the reader and other processes that influence the quality of the diagnostic procedure.

U.S. Pat. No. 7,267,799, the entire content of which is incorporated herein by reference is addressed to provide a universal optical imaging test system comprising a reader and a method to provide the reader with calibration data. However, the data relevant to the test and the data relevant to calibration are transferred in different manners.

It would be advantageous to have a reader that enables the use of the same method and same optical sensing means for reading the specimen related data and peripheral data pertaining to the test kit, the patient information such as ID, name and his or her biometric stamp and the like.

### BRIEF SUMMARY

Accordingly, it is a principal object of the present invention, in embodiments thereof, to provide an apparatus for optically reading test kits having an identification data zone associated with the test kit and test zone arranged to receive a test substance. The apparatus comprises an optical sensing module, an image processing module coupled to the optical sensing module, a control module coupled to the optical sensing module and to the image processing module. The optical sensing module is arranged to sense both the test zone and the identification data zone and deliver the sensed data to the image processing module responsive to the control module. Further, the image-processing unit is arranged to perform image processing on the sensed data from the test zone and from the identification data zone and further determine the test substance according to the sensed data from the test zone in view of the sensed data from the identification data zone responsive to the control unit.

In embodiments, the present invention discloses a method of optically examining a biological substance specimen in an examination device and transferring data relating to the specimen and further data relating to the production process of the examination device. The method comprises the stage of optically sensing a biological substance specimen. Then the method goes on to the stage of processing the optically sensed data. Then the method goes on to the stage of transferring the processed data and the stage of transferring data relating to the production process of the examination device.

### BRIEF DESCRIPTION OF THE DRAWINGS

The subject matter regarded as the invention will become more clearly understood in light of the ensuing description of embodiments herein, given by way of example and for purposes of illustrative discussion of the present invention only, with reference to the accompanying drawings (Figures, or simply “FIGS.”), wherein:

FIG. 1 is a high level block diagram showing the apparatus according to some embodiments of the present invention;

FIG. 2 is a high level flow chart showing stages of the method according to some embodiments of the present invention;

FIG. 3 shows a high level flowchart depicting stages of a variation of the method according to some embodiments of the invention; and

FIG. 4 is an isometric view showing the apparatus according to some embodiments of the present invention.

The drawings together with the description make apparent to those skilled in the art how the invention may be embodied in practice.

### DETAILED DESCRIPTION OF THE INVENTION

In the following detailed description, numerous specific details are set forth in order to provide a thorough understanding of the disclosure. However, it will be understood by those skilled in the art that the teachings of the present disclosure may be practiced without these specific details. In other instances, well-known methods, procedures, components and circuits have not been described in detail so as not to obscure the teachings of the present disclosure.

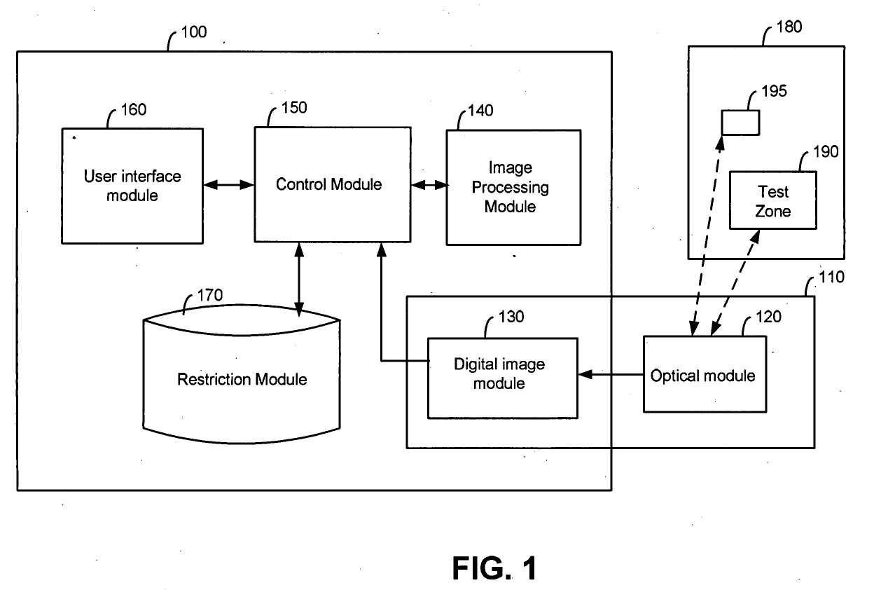

FIG. 1 shows a high level schematic block diagram of an apparatus (a reader) 100 for optically reading test kits 180 having an identification data zone 195 associated with test kit 180 and a test zone 190 containing a chemically responsive substance arranged to receive a test substance. The apparatus 100 comprises an optical sensing module 110, comprising an optical module 120 and a digital image module 130, an image processing module 140 coupled to optical sensing module 110, a control module 150 coupled to optical sensing module 110 and to image processing module 140.

Optical sensing module 110 is arranged to sense both test zone 190 and identification data zone 195 (either simultaneously or sequentially) and deliver the sensed data to image processing module 140 responsive to control module 150. Further, image processing module 140 is arranged to perform image processing of the sensed data from test zone 190 and from identification data zone 195 and further determine the test substance according to the sensed data from test zone 190 in view of the sensed data from identification data zone 195 responsive to control unit 150.

According to some embodiments of the invention, apparatus 100 may be arranged to be operatively associated with a plurality of test kits, each deigned to perform a different test directed at a different test substance. The test substance may be varied such as biological material, bodily substance, chemical specimen and the like. The type of test and/or other parameters are determined by optically sending the test zone and the data zone.

According to some embodiments of the invention, the identification data may be any kind or format of data that pertains to the test kit itself and is required in the image processing process of the test zone or restrict it. Non limiting examples of identification data may comprise type of test, mode of test, calibration data, date of production, identification number, batch number, Biometric information such as fingerprint image placed in the data zone and the like.

According to some embodiments of the invention, test zone 190 is arranged to receive a test substance and provides a visual representation of properties pertaining to the test substance according to a predefined key.

According to some embodiments of the invention, optical sensing module 110 is arranged to optically sense test zone 190 and identification data zone 195 simultaneously.

According to some embodiments of the invention, optical sensing module 110 comprises an optical unit 120 and a digital imaging module 130, wherein digital imaging module 130, image processing module 140, and control module 150 are implemented on the same integrated circuit.

According to some embodiments of the invention, apparatus 100 further comprises a printed circuit board, and wherein the optical sensing module 110, the image processing module 140, and the control module 150 are implemented on the same printed circuit board.

According to some embodiments of the invention, apparatus 100 further comprises a rechargeable power source. The rechargeable power source may comprise an electromagnetic power source operatively associated with a complementary power source activator located on the test kit 180. Charging of the rechargeable power source is achieved in cooperation of the apparatus and the test kit by converting mechanical force into electrical power.

According to some embodiments of the invention, apparatus 100 further comprises a restriction module 170 coupled to the control module. Restriction module is arranged to store restriction data pertaining to restricting the use the test kits. The control data is further arranged to restrict the use of the apparatus responsive to the restriction data.

According to some embodiments of the invention, restriction data may be any one of the following non-limiting examples: an upper bound of a number of test kits; and identification data associated with predefined test kits and the like.

According to some embodiments of the invention, apparatus 100 further comprises a user interface module 160 and, wherein the user interface module is coupled to the control unit, wherein the user interface is arranged to enable a user to select a mode and type of operation from a predefined modes and types of operation.

According to some embodiments of the invention, apparatus 100 comprises a disposable portion and a reusable portion and wherein the disposable portion is being arranged to disengage from the reusable portion. Alternatively the entire apparatus can be a disposable unit.

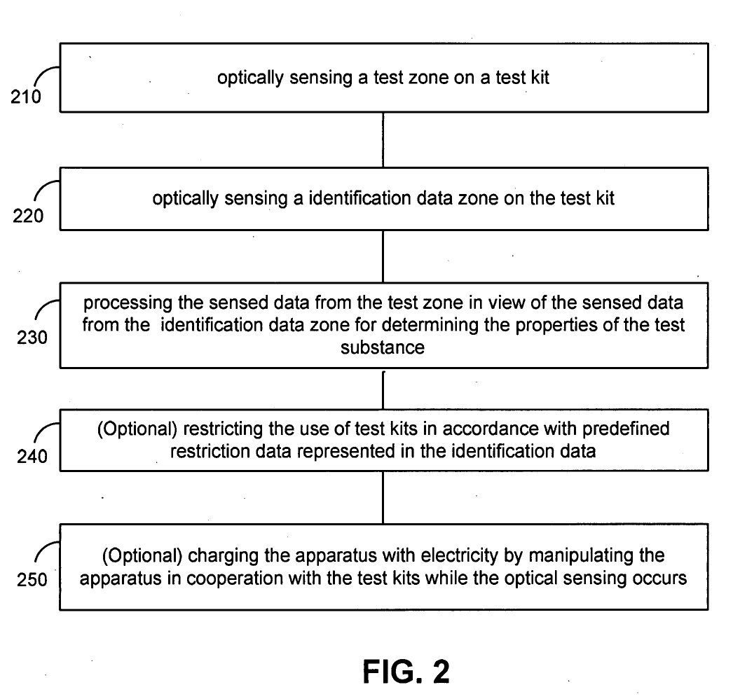

FIG. 2 shows a high level flowchart depicting stages of the method according to some embodiments of the invention. The disclosed method is a method of optically sensing a test kit having an identification data zone associated with the test kit and a test zone arranged to receive a test substance. The method comprises: optically sensing the test zone 210; optically sensing the identification data zone 220; and processing the sensed data from the test zone in view of the sensed data from the identification data zone for determining the properties of the test substance 230.

According to some embodiments of the invention, both acts of optically sensing the test zone and optically sensing the identification data zone occur simultaneously.

According to some embodiments of the invention, the method further comprises restricting the use of test kits in accordance with predefined restriction data represented in the identification data 240.

According to some embodiments of the invention, the method further comprises charging the apparatus with electricity by manipulating the apparatus in cooperation with the test kits while the optical sensing occurs 250.

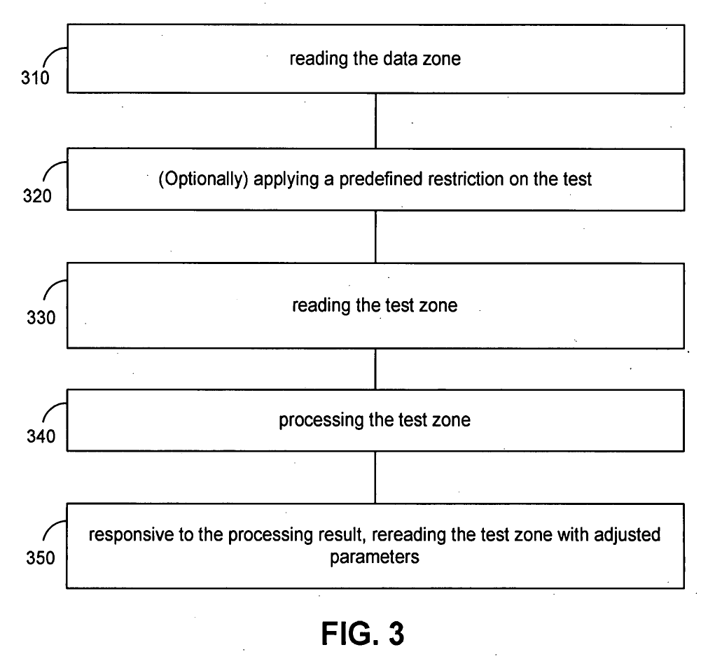

FIG. 3 shows a high level flowchart depicting stages of a variation of the method according to some embodiments of the invention. The method comprises: reading the data zone 310; (Optionally) applying a predefined restriction on the test 320; reading the test zone 330; processing the test zone 340; and responsive to (depending on) the processing result, rereading the test zone with adjusted parameters 350.

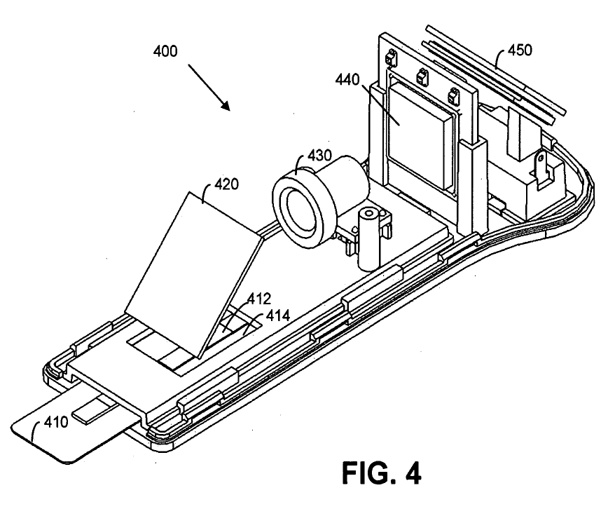

FIG. 4 is an isometric view showing the apparatus, with the housing removed, according to some embodiments of the present invention. The apparatus 400 according to this embodiment is arranged to receive a test kit 410 having a test zone 412 and an identification zone 414. In operation, test kit 410 is slipped through a dedicated slot; a mirror 420 reflects the image of test zone 412 and identification zone 414 via lens 430 to digital processing module 440. After analysis is performed in the processing unit (not shown), the information is either displayed on a display 450 or transferred via a data transference module (not shown). It is understood that other implementations are possible and the embodiment described above is merely an example.

According to some embodiments of the invention, the method further comprising analyzing the biometric representation and storing the analyzed biometric representation associated with the test kit. The biometric information may be presented on the test kit from the test fluid/bio-sample taken from the patient/donor to perform the same test, or additional fluid/bio-sample for the biometric identification itself. The biometric presentation can be an outcome from chemical or biological reaction that can be read by the optical system. Such representation may be DNA prints, blood types, etc. Also the biometric information may be an attachment of a photo to the test kit as a label or as a fingerprint to be attached as a label. A fingerprint can be directly be printed on the test kit by using ink, powder or any other mean for direct print on the test kit.

According to some embodiments of the invention, the test substance may be used to biometrically identify the person providing the test substance. Further, the biometric identification may be used in conjunction with the test results in order to refer specific test results to a specific person (e.g., in drug use tests). Specifically, the biometric data may be taken from the tested biological sample or other biological material taken from the same Human/Animal or any life form. Such biometric material can be intermediate form, such as: photos, images, prints and such information which relates to the tested life form.

According to some embodiments of the invention, the apparatus is arranged to conceal or encrypt the test results, making it impossible for the immediate user to see or analysis of the test results. Rather, the test result will be send via a communication channel (USB, RF and the like) to a server/doctor to be analyzed in a remote site.

Portions of the apparatus may be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory, a Flash memory or a random access memory or a combination thereof. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the reader can be implemented on a computer having a display device such as a LCD (liquid crystal display) monitor for displaying information to the user and a keyboard and a pointing device such as a mouse or a trackball by which the user can provide input to the computer.

The invention can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a cellular telephony network, a LAN, a WAN, wireless LAN or Bluetooth, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention can be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Those skilled in the art will envision other possible variations, modifications, and applications that are also within the scope of the invention. Accordingly, the scope of the invention should not be limited by what has thus far been described, but by the appended claims and their legal equivalents.

What is claimed is:

1. An apparatus for optically reading test kits having an identification data zone associated with the test kit and test zone arranged to receive a test substance comprising:
an optical sensing module;
an image processing module coupled to the optical sensing module; and
a control module coupled to the optical sensing module and to the image processing module,
wherein the optical sensing module is arranged to sense the test zone and the identification data zone and deliver the sensed data to the image processing module responsive to the control module, and
wherein the image processing unit is arranged to perform image processing on the sensed data from the test zone and from the identification data zone and further determine the test substance according to the sensed data from the test zone in view of the sensed data from the identification data zone responsive to the control unit.

2. The apparatus according to claim 1, wherein the control module is further arranged to store all sensed data and or analyzed parts thereof in association with the identification data.

3. The apparatus according to claim 1, wherein the test substance is one of: a biological material; a bodily substance; a chemical specimen; and any other chemical reaction visible to an optical sensing device.

4. The apparatus according to claim 1, wherein the identification data is one of: a type of test; a mode of test; calibration data; data of production; an identification number; a batch number; and any data that is representable in an optical form.

5. The apparatus according to claim 1, wherein the identification data contains a graphical calibration of the test, such that the calibration data contains a plurality of parameters which are used to calibrate the test results according to different functions.

6. The apparatus according to claim 1, wherein the identification data contains biometric information related to one or more of: the test; the patient; a donor; and the tester.

7. The apparatus according to claim 1, wherein the test zone is arranged to receive a test substance and provides a visual representation of properties pertaining to the test substance according to a predefined key.

8. The apparatus according to claim 1, wherein the optical sensing module is arranged to optically sense the test zone and the identification data zone simultaneously.

9. The apparatus according to claim 1, wherein the optical sensing module comprises an optical unit and a digital imaging module, and wherein the digital imaging module, the image processing module, and the control module are implemented on one of: a single integrated circuit; a single substrate; and a combination thereof

10. The apparatus according to claim 1, further comprising a printed circuit board, and wherein the optical sensing module, the image processing module, and the control module implemented on a single printed circuit board.

11. The apparatus according to claim 1, further comprising one of: a rechargeable power source; batteries; and external power supply.

12. The apparatus according to claim 8, wherein the rechargeable power source comprises an electromagnetic based electricity generator operatively associates with a complementary power source activator located on the test kit, wherein charging of the rechargeable power source is achieved in cooperation of the apparatus and the test kit.

13. The apparatus according to claim 1, further comprising a restriction module coupled to the control module, wherein the restriction module is arranged to store restriction data pertaining to restricting the use the test kits and wherein the control data is further arranged to restrict the use of the apparatus responsive to the restriction data.

14. The apparatus according to claim 10, wherein the apparatus is activated upon insertion of the test kit thereto.

15. The apparatus according to claim 10, wherein the restriction data is one of: an upper bound of number of test kits; identification data associated with predefined test kits; a batch number of test kit; a delivery number of test kit; a serial number of test kit; an expiration date of test kit; and a type of test.

16. The apparatus according to claim 1, further comprising a user interface module and, wherein the user interface module is coupled to the control unit, wherein the user interface is arranged to enable a user to select a mode and type of operation from a predefined modes and types of operation.

17. The apparatus according to claim 1, which the test results are sent to a server or terminal or printer in a remote location by one of: a Universal Serial Bus (USB) interface; a cellular, radio frequency (RF) interface; an optical interface; and a line interface.

18. The apparatus according to claim 1, wherein the apparatus comprises a disposable portion and a reusable portion and wherein the disposable portion is arranged to disengage from the reusable portion.

19. A method of optically sensing a test kit having an identification data zone associated with the test kit and a test zone arranged to receive a test substance, the method comprising:
optically sensing the test zone;
optically sensing the identification data zone; and
processing the sensed data from the test zone in view of the sensed data from the identification data zone for determining the properties of the test substance.

20. The method of claim 19, wherein optically sensing the test zone and optically sensing the identification data zone occur simultaneously.

21. The method of claim 19, wherein optically sensing the test zone and optically sensing the identification data zone occur one after the other.

22. The method of claim 19, further comprising restricting the use of test kits in accordance with predefined restriction data represented in the identification data.

23. The method of claim 19, wherein the processing the sensed data provides biometric identification of the provider of the test substance.

24. The method of claim 19, wherein the test results are concealed from the immediate user and are delivered to a remote site for further analysis.
